(19) United States
(12) Patent Application Publication
(10) Pub. No.: US 2003/0026978 A1
(43) Pub. Date: Feb. 6, 2003

(54) Protechtor

(76) Inventor: Robert Nicoleau, Baldwin, NY (US)

Correspondence Address: ROBERT NICOLEAU, 866 SHUBERT ST., BALDWIN, NY, 11510, US

(21) Appl. No.: 10/188,264

(22) Filed: Jul. 2, 2002

Related U.S. Application Data
(60) Provisional application No. 60/310,216, filed on Aug. 6, 2001.

(51) Int. Cl. B32B 7/12

(52) U.S. Cl. 428/352

(57) ABSTRACT

Plastic or paper signs and stickers affixed to glass typically come loose due to wear and tear, the elements, but most of the damage to these stickers is due to cleaning product usage.

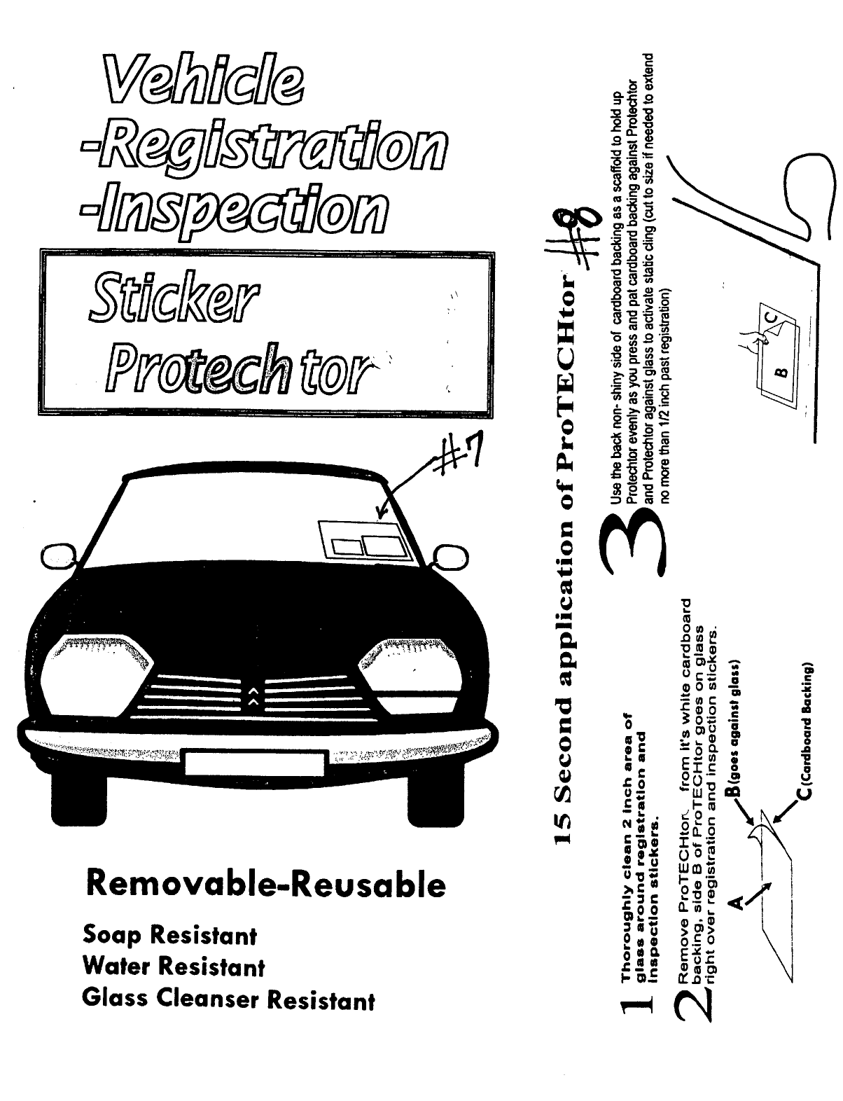

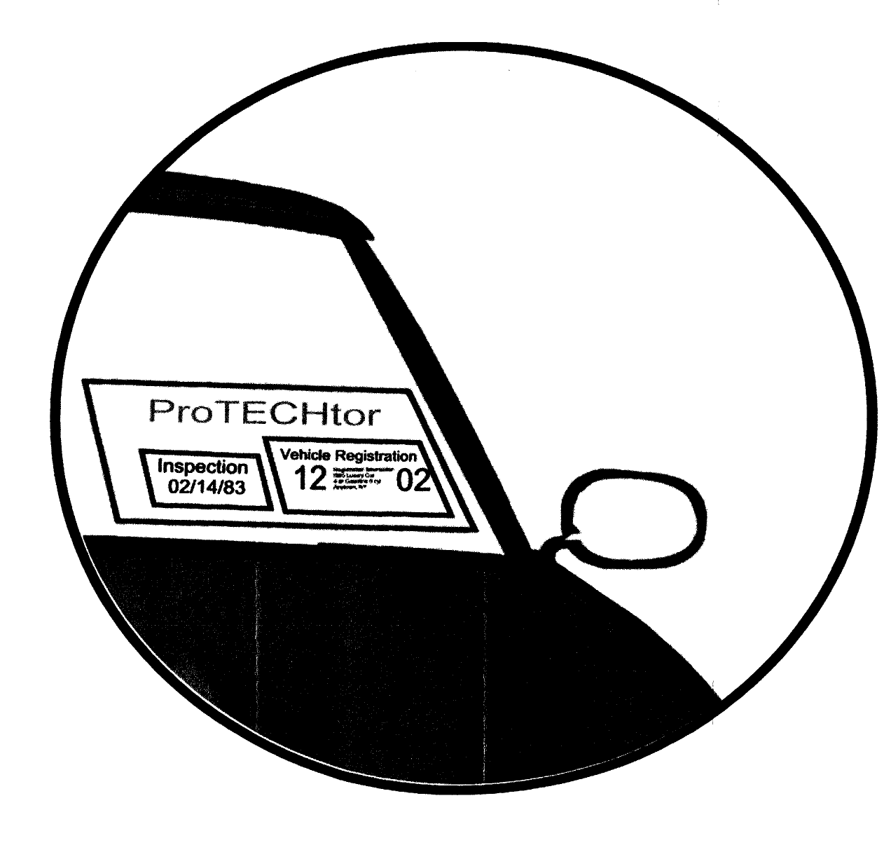

Government issued automobile registration and inspection stickers are protected by my invention, furthermore, when these issued stickers expire my invention is removable so that the new sticker can be put on the windshield and the same PROTECHTOR is re-applied over the new registration sticker again.

### CROSS-REFERENCE TO RELATED APPLICATIONS

Provisional Patent Application No.—60/310,216

Filing date—08/06/2001

Confirmation Number—8425

### STATEMENT REGARDING FEDERALLY SPONSORED RESEARCH OR DEVELOPMENT

Not Applicable

### BACKGROUND OF INVENTION

Plastic or paper signs or stickers affixed to glass doors, windows, automobile windshields, typically come loose, fray at the edges due to wear and tear, or the effects of the elements, and most detrimental to these sometimes legally mandated stickers is the constant routine cleaning of the glass door, window, or automobile windshield glass. My invention protects these stickers.

### BRIEF SUMMARY OF INVENTION

My invention is a removable and reusable vinyl static cling sheet that is made to a size such that it extends 1\2 inch beyond all 4 sides of the affixed glass sticker it is to protect. My invention uses this 1\2 inch to static cling to the glass and is thus removable and reusable and does not stick to the sticker itself.

### BRIEF DESCRIPTION OF SEVERAL VIEWS OF THE DRAWING

#7—an automobile with a PROTECHTOR installed on the inside of the windshield against the registration and inspection stickers thus protecting the paper registration and the paper vehicle inspection stickers from the wet towels used in car washes.

#8—Instructions on how to apply PROTECHTOR in 15 seconds.

### DETAILED DESCRIPTION OF THE INVENTION

My invention is made by using clear static cling sheets manufactured by various companies. The sheet is then coated with an epoxy enamel and is allowed to dry under air flow at room temperature, the air flow accelerates the drying of the epoxy enamel and thus we still have the waterproofing, detergent resistant properties of the epoxy and we have simultaneously not given the epoxy time to interact and spoil the static properties of the static material its been applied on.

The sheets are cut to size to extend 1\2 inch beyond the border of the stickers they are to protect. My invention clings on to the glass with this 1\2 inch all around the sticker it does not stick or bind to the sticker in any way and is thus removable and reusable.

The improvement invented is the application of the coat of epoxy which extends the life of the static cling material by protecting it against glass cleaning products and detergents routinely used to clean glass doors windows and auto windshield.

1. My invention protects paper and plastic signs and stickers affixed to glass doors, glass windows or automobile windshields, from the damaging effects caused by the cleaning compounds routinely used to clean these glass surfaces.
